(19) United States
(12) Patent Application Publication
(10) Pub. No.: US 2011/0129201 A1
(43) Pub. Date: Jun. 2, 2011

(54) CUSTOMIZED PLAYBACK OF BROADCAST MEDIA

(75) Inventor: James G. McLean, Fuquay-Varina, NC (US)

(73) Assignee: INTERNATIONAL BUSINESS MACHINES CORPORATION, Armonk, NY (US)

(21) Appl. No.: 12/628,170

(22) Filed: Nov. 30, 2009

(51) Int. Cl. H04N 5/91; H04N 7/08; H04N 5/445; H04N 5/76; H04N 5/93; G11B 27/00

(52) U.S. Cl. 386/296; 725/56; 386/E05.003; 386/297; 386/290

(57) ABSTRACT

One embodiment provides a method of providing a controlled, customized playback of broadcast media, such as satellite radio or television. A subset of preferred channels is identified from a set of available broadcast channels. Each broadcast channel provides streaming content including media segments and, optionally, segment tags marking the beginning and end of each media segment. Complete media segments of the streamed content from the preferred channels are received and stored. A plurality of queues is maintained. The received content from each channel is placed in one of the queues in the order received. A customized playback sequence is generated. In generating the customized playback sequence, the queued media segments are selected according to channel-selection criteria, and each media segment is played back in its entirety.

### BACKGROUND

1. Field of the Invention

The present invention relates to digital media broadcasting and playback of broadcast multimedia content.

2. Background of the Related Art

Audiovisual media is available in a streaming format from a variety of sources. Media may be streamed by continuously transmitting the media from a source to a receiving device in a format that can be processed and played back as it is being received by the receiving device. Normally, this is done without leaving a residual copy of the media on the receiving device. These characteristics distinguish streaming media techniques from both non-streaming media, which has been previously stored on a client device for subsequent playback, and from pseudo-streaming media, which allows a downloading media file to be played back while the download is in progress. Streaming media includes traditional broadcast formats, such as analog radio and television broadcasts. Digital technologies have expanded the available streaming media formats, to include satellite radio and television, for example.

Digital broadcast media, such as satellite television and radio, provide content on a large number of simultaneously-broadcast channels. The abundance of available channels has fostered the creation of individual channels having very specific content, which is sometimes referred to as narrowcasting. For example, satellite radio channels have been created having content limited to a particular decade, genre, special interest, or even to a particular musical artist. While a multimedia user might be interested in the content of a specific channel, the user will typically be interested in content from other channels, as well. Thus, the user may change channels several times during a listening session, which is often referred to as surfing. While switching channels, the user will normally encounter fragments of songs, newscasts, and other content that are already in progress.

### BRIEF SUMMARY

One embodiment of the present invention provides a method. A subset of preferred channels is identified from a set of available broadcast channels. Each broadcast channel provides streaming content including media segments. Complete media segments of the streamed content from the preferred channels are received and stored. A plurality of queues is maintained. Maintaining the queues includes placing the received content from each channel in one of the queues in the order received. A customized playback sequence is generated by selecting the queued media segments according to channel-selection criteria. Media segments are played back according to the customized playback sequence.

Another embodiment of the invention provides a streaming media playback system. The system includes a receiver configured for receiving and storing selected portions of a digitally-encoded multi-channel broadcast. A digital decoder is configured for decoding the multi-channel broadcast. A demultiplexer is configured for separating the multi-channel broadcast into separate channels. A sequence generator is configured for applying predefined channel-selection criteria to select channels, selecting complete media segments to be stored from the selected channels, queuing the stored media segments, and generating a playback sequence from the queued media segments. A media player is configured for playing back all of the queued media content according to the customized playback sequence.

### BRIEF DESCRIPTION OF THE SEVERAL VIEWS OF THE DRAWINGS

FIG. 1 is diagram of a multimedia system according to an embodiment of the invention.

FIG. 2 is a representative graphical user interface (GUI) for use with the multimedia system of FIG. 1.

FIG. 3 is a flowchart outlining a method of providing customized playback of broadcast media according to an embodiment of the invention.

### DETAILED DESCRIPTION

One embodiment of the present invention provides a method wherein the content of a preferred subset of channels selected from a streaming, multi-channel digital broadcast are stored and queued for customized playback. The streamed content of each channel may be queued in an associated queue in the order in which it is streamed. The queued content from the preferred subset of channels may then be selected for playback according to user-specific channel selection criteria. The channel selection criteria may include channel ratings, whereby the queued content for each preferred channel is selected for playback at a frequency weighted according to the respective channel ratings. The channels may be randomly or sequentially selected from among the preferred subset for playback of the saved and queued content. The queued content from each of the various channels is automatically selected and introduced into a playback sequence. Over time, at least certain segments of the queued content from each of the preferred channels are played back.

Storing and queuing the content of the preferred channels allows the user to receive complete segments of the content being broadcast (i.e. media segments), without encountering the fragments of songs, newscasts, and other content that would conventionally result when surfing channels. After being played back, each media segment of queued content may be removed from memory (i.e. deleted) after being played back. Removing stored content after playback preserves memory by continually freeing memory space for additional streaming content being stored and queued. Removing content after playback also protects the interests of copyright owners, by disallowing the temporarily stored content from being retained in memory for unlimited playback.

Although some delay may occur between the time that content is streamed, queued and subsequently played back, the stored content may be played back in a sufficiently timely manner to remain current and relevant. For example, most queued music will be timely if played back on the same day as originally broadcast. More time-sensitive content, such as newscasts, may be introduced into the content stream between two queued media segments, either as they occur or on a periodic basis. Particularly urgent content, such as emergency weather bulletins, may be introduced immediately, while pausing any currently playing content. After the urgent content has been played back, the paused content may resume, so that the entirety of the queued content is eventually played.

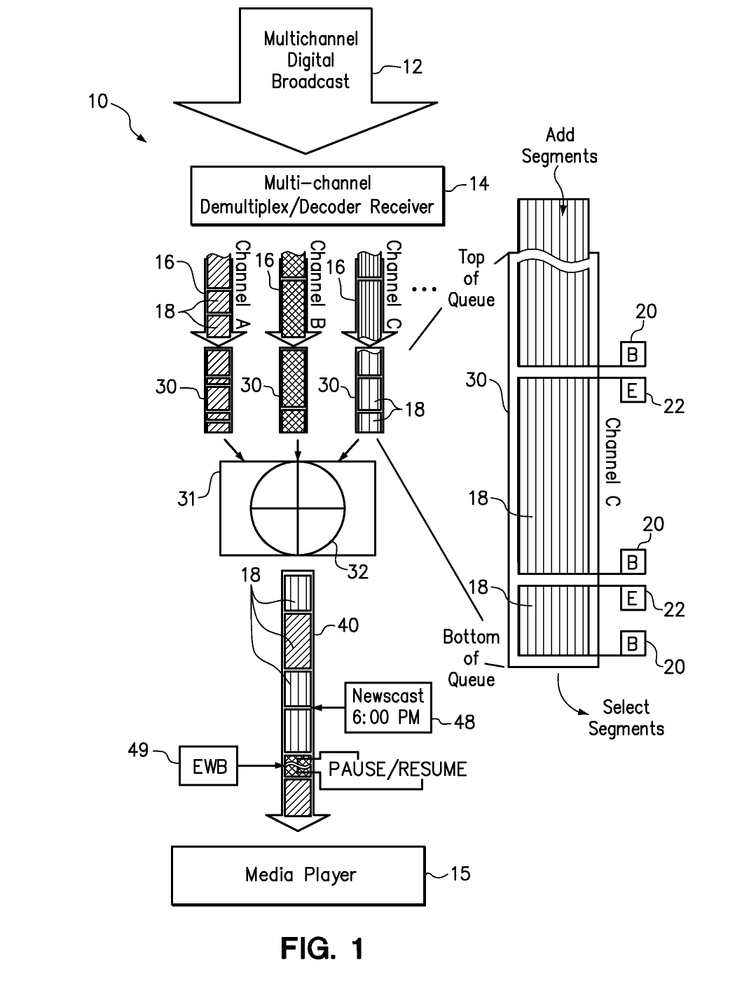

FIG. 1 is a diagram of a multimedia system 10 according to an embodiment of the invention. The system 10 includes a receiver 14 for receiving and decoding a multi-channel digital broadcast 12 and a media player 15 for playing back a customized playback sequence. The media player 15 is optionally a component of the receiver 14. The multi-channel digital broadcast 12 includes digital multimedia content broadcast on a plurality of individually selectable channels. The digital multimedia content may include digitally encoded audio, video, or a combination thereof. The term “broadcast” is not limited to transmissions over conventional airwaves. The multi-channel digital broadcast 12 may be transmitted in an encoded form over any of a variety of mediums, including not only the airwaves, but also satellite, cable, fiber channels, and other mediums capable of transmitting digital content. Examples of such broadcasts include digital television and radio broadcasts carried over the airwaves, subscription-based television and radio broadcasts transmitted by satellite or over the Internet, and “cable radio” channels provided as part of a cable television service. The receiver 14 decodes the received content of the broadcast 12, and includes a demultiplexer to separate the content into individual channels 16. Some of the channels are individually referenced for purpose of discussion as Channel A, Channel B, and Channel C.

Any number of channels 16 may be provided by the multi-channel digital broadcast 12. For example, satellite radio and television broadcasters may broadcast hundreds or even thousands of channels. The content of the channels 16 includes individual media segments 18. Each media segment has a defined length with a logical beginning and end. For example, a single media segment may be a complete song, television show, newscast, weather report, or sportscast. The content of each channel is streamed, providing a chronological sequence of media segments 18. The sequence of media segments 18 are streamed according to any of a variety of streaming techniques known in the art that would allow the media segments 18 to be conventionally played back in real-time, in the order received, on the media player 15. This chronological sequence of media segments 18 is diagrammed as a series of blocks in each channel 16.

For ease of visually identifying the different media segments 18 in the figure, each media segment 18 is drawn as a separate block. However, the media segments 18 may be provided as part of a continuous stream of data, with “segment tags” used as delimiters to identify the separate media segments 18 carried within the continuous data stream of any given channel. As shown in the expanded view of Channel C, the segment tags include a beginning segment tag 20 marking the beginning of each media segment 18 and an ending segment tag 20 marking the end of each media segment 18. The beginning and ending segment tags 20, 22 identify to the media player 15 where each media segment 18 begins and ends, so that the media player 15 may play back complete media segments in their entirety. Media segments that have not yet been fully received for a particular channel are illustrated in FIG. 1 using broken lines extending above the top of the associated queue 30.

The streaming content of the channels 16 may conventionally be performed by a player in real-time, with a minimal delay required to digitally decode the content, and without requiring a residual copy of the content to be retained in memory. However, according to a feature of this embodiment, the receiver 14 stores the received content in memory, temporarily but not indefinitely, so that the media segments may be played back in their entirety in a customized playback sequence determined according to user-specific channel-selection criteria. The received content of the channels 16 may be stored in a hardware-based memory device, such as a hard-drive or flash memory. The content of all of the channels 16 may physically be stored together within the same hardware device, but channel associations are maintained so that each of the stored media segments is associated with the channel on which it was broadcast.

A plurality of queues 30 are maintained, with each queue 30 associated with a respective one of the channels 16 that a user has selected. For visual reference, each queue 30 is drawn directly below the channel 16 with which it is associated. The content of each channel 16 is queued on a first-in, first out basis, wherein media segments for a particular channel 16 are arranged in the associated queue 30 in the order received by the receiver 14, i.e., with the media segments in the same order as the broadcast for a particular channel. Thus, each media segment 18 received and decoded for a particular channel 16 is added to the top of the associated queue 30. The queues 30 may be allocated with a predetermined queue size.

The queue size is preferably large enough to hold several media segments. In the rare case that a media segment being streamed is larger than the queue size (e.g. a 1 GB media segment versus a 500 MB queue), then the media segment may be rejected and not saved or queued. If the media segment being streamed is smaller than the queue size, but simply larger than the currently available space in the queue (such as due to the presence of other queued media segments), then the media segment may be saved and the queuing of the media segments delayed until the available queue space is sufficient. For example, a media segment whose file size exceeds the currently available queue space for the associated queue may be saved and subsequently queued after other content from the queue has been played back and removed from that queue.

It should be noted that queues 30 are not required to be provided for all of the available channels. Rather, queues 30 may only be provided for a preferred subset of preferred channels. As will be further described below, a user may select the preferred subset of channels from a larger set of available channels as provided by a broadcaster. Furthermore, hardware capacity may limit the number of queues that may be provided.

A sequence generator 31, which may be a component of the receiver 14 or otherwise in communication with the receiver 14, generates a customized playback sequence 40 by applying a set of user-specific channel-selection criteria 32 to select a portion of the queued media segments 18. Each media segment 18 that is introduced into the playback sequence 40 is selected from one of the queues 30. More particularly, each media segment 18 in the playback sequence 40 may be determined by applying channel selection criteria 32 to periodically select a channel 16, and selecting the media segment 18 at the bottom of the queue 30 associated with the selected channel 16. Each selected media segment 18 that is introduced into the playback sequence 40 is taken from the bottom of the queue 30 from which it is selected, and will preferably be removed from the queue and from memory after the content is played back in its entirety. When a currently playing media segment ends, as identifiable by the ending segment tag 22 for the currently playing media segment, the next media segment in the playback sequence 40 begins to be played back, and so forth.

The queues 30 may be allotted with a predefined queue size, due to the finite memory available for storing received content. The media segments 18 in the playback sequence 40 are typically played back one at a time, while media segments 18 are simultaneously being added to the queues 30 for multiple channels. Due to the finite memory and queue size, not all of the content being broadcast is stored and queued. Rather, according to one embodiment, the queues 30 may initially be filled with content from each of the respective selected channels 16. Then, additional media segments 18 may be stored in memory and added to the particular queue 30 only if sufficient queue space is available. To continually free queue space, each media segment 18 that is added to the playback sequence 40 may be removed from the queue 30. To continually free memory for storing new content, each media segment 18 may also be removed from memory after being played in the customized playback sequence 40.

A number of different channel selection criteria 32 may be applied in the selection and playback of the queued content. One example of a user-specific channel-selection criterion is a channel rating that relates to the degree of user preference. Channel ratings are optionally expressed using a numerical scale, such as a scale from 1 to 10 where a rating of ten indicates the strongest user preference and a rating of one indicates the weakest user preference. Each channel may alternatively be given a star-rating, such as a rating of between one to five stars, where the number of stars indicated the degree of preference. A text rating may indicate the preference in words, such as a “high,” “medium,” or “low preference” for a particular channel. When generating the customized playback sequence 40, queued media segments may be selected for playback in weighted relation to the channel ratings. Thus, content from a channel having a higher channel-rating may be automatically selected with greater frequency than content from a channel having a lower channel-rating.

The channel-ratings are preferably user-specific. The channel-rating may be explicitly assigned by the user. For example, the user may individually rate each channel. Alternatively, the channel ratings may be determined based on usage patterns unique to the particular user. For example, the system 10 may analyze a user history file or otherwise monitor the frequencies with which the user has manually selected channels in prior user sessions, and generate channel ratings proportional to those frequencies. Channel ratings based on actual, prior usage would typically be dynamic. For example, over time, a user's listening habits for satellite radio may change, reflecting the user's changing preferences. The usage patterns for the user may be monitored, and channel ratings may be automatically adjusted to reflect the user's changing usage patterns.

Additional examples of channel-selection criteria include random channel selection, sequential channel selection, and time-dependent channel selection. If random channel selection is used, then channels from which to play back queued content may be selected randomly. If sequential channel selection is instead used, then channels from which to play back queued content may be selected sequentially. If time-dependent channel selection is instead used, then channels from which to play back queued content may be influenced by the date, the day of the week, or the time of day.

FIG. 1 illustrates an example in which the channel selection criteria 32 include a channel rating in combination with random selection. That is, queued media segments from the user-preferred channels are selected randomly, but in weighted relation to a channel rating. To illustrate, the media segments 18 in the playback sequence 40 are randomly arranged, but are selected from among the channels with a frequency in proportion to the respective channel ratings. In this example, Channels A, B, and C may have a two-star, one-star, and three-star rating, respectively. As a consequence, media segments for Channel C will be selected an average of three times as often as media segments for Channel B. Here, the portion of the playback sequence 40 includes three media segments from Channel C, one media segment from Channel B, and two media segments from Channel A. The playback sequence 40 is provided for purposes of illustration, and an actual playback sequence 40 may include a greater or lesser number of segments at any given time.

In another example, channel ratings may be applied in combination with sequential selection, rather than random selection. Queued media segments may be taken from a repeating sequence of Channels, such as Channels A, B, C, A, B, C, etc., but in proportion to the channel ratings for Channels A, B, and C. An excerpt of a customized playback sequence might then include a repeating pattern of, for example, two songs selected from Channel A, followed by one song selected from Channel B, and then followed by three songs selected from Channel C.

Another example of a channel selection criterion is a “most recently queued” feature. Using this criterion, the next song to be played back in the playback sequence 40 at the conclusion of a currently-playing media segment is selected from the bottom of the queue having the most recently received and stored media segment. The most recently received and stored media segment will have been added to the top of one of the queues 30, and the next song to be played back in the playback sequence 40 may be selected from the bottom of that queue 30, to offset the limited queue space occupied by the most recently added media segment.

Additional content from the multi-channel broadcast may be automatically introduced into the playback sequence 40 intermittently, such as at specified times or time intervals. Time-sensitive content, such as newscasts, may be selected for introduction, without the larger delays that would otherwise accompany queuing that content. For example, a 6:00 PM newscast 48 is introduced between two of the media segments 18 of the playback sequence 40. Unlike the other media segments 18, the newscast 48 in this instance is not required to cycle through one of the queues 30 from top to bottom, which would otherwise delay playing back the newscast 48. Rather, the newscast 48 is directly inserted into the playback sequence 40, between two other Channel C media segments. In the interest of playing back full media segments rather than fragments, the system 10 may wait for the currently playing media segment to end before introducing the newscast 48, resulting in a slightly increased delay between when the newscast 48 is broadcast and when the newscast 48 is actually played back as part of the playback sequence 40. Still further, the newscast 48 may be played as it is streamed to the receiver, or only after the entire newscast segment has been received and stored.

In response to the broadcast of particularly time-sensitive content, such as an emergency weather bulletin (EWB) 49, the system 10 may interrupt a currently playing media segment to introduce the urgent content. However, in the interest of playing back complete media segments, the system 10 may pause (rather than cancel) the playback of the interrupted media segment during the urgent content, and resume playback of the paused media segment at the conclusion of the EWB 49 or other urgent content.

In the embodiment of FIG. 1, a separate queue 30 is provided for each channel 16 to be included in the playback sequence 40, whether all of the available channels or just a preferred subset of channels is included. Thus, the number of available queues may be fewer than the number of available channels. Instead, the number of queues may be limited to the number of channels in the preferred subset of channels.

FIG. 1 shows the channel-selection criteria being applied after the content is queued. Alternatively, the channel selection criteria may be applied before the content is queued. For example, using a channel rating as the selection criterion, roughly twice as much content may be queued from a 4-star channel than from a 2-star channel. Then the queued content from the 4-star channel may be played back roughly twice as often as queued content from the 2-star channel.

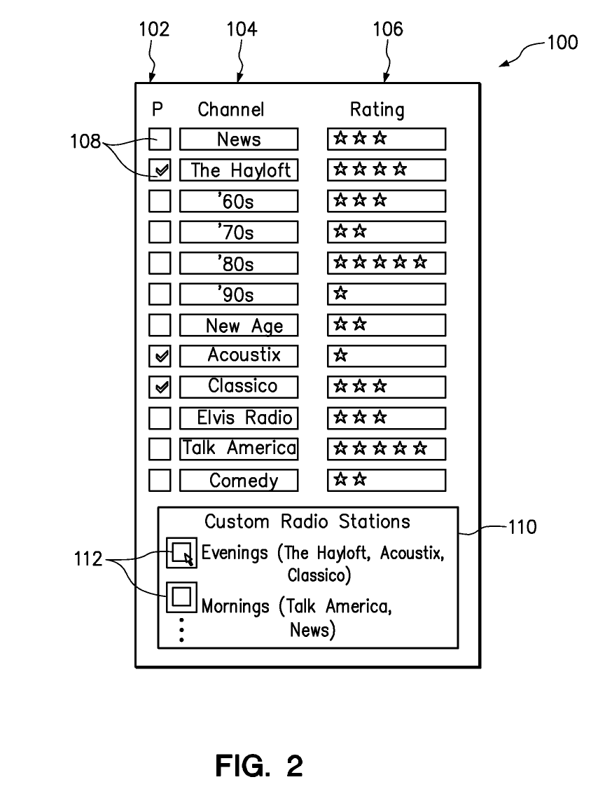

FIG. 2 is a representative graphical user interface (GUI) 100 according to an embodiment of the invention. The GUI 100 may provide an interface for a user to interact with the system 10 of FIG. 1. The GUI 100 displays a list of available channels in a channel column 104. The broadcast channels may include many other channels not included in the preferred channels listed in the GUI 100. The channel names are selected according to the content of the channels. The channel names are preferably selected so that a user may easily associate the type of content with the name of the channel. For example, the content of the “News” channel is primarily or exclusively news; the “Hayloft” channel contains country-western music and news, and “Elvis Radio” is dedicated to the music of Elvis Presley and other related content, such as audio biographies and interviews of that musical artist.

A channel selection column 102 of the GUI 100 provides toggle selectors 108 for dynamically selecting a subset of preferred channels from among the available channels listed in column 104. Each toggle selectors 108 may be toggled between two mutually-exclusive states, e.g. a selected state and a non-selected state. The toggle selectors 108 are embodied in FIG. 2, by way of example, as checkboxes. Each channel from column 104 may be alternately selected (i.e. placed in a selected state) and deselected (i.e. placed in a non-selected state) by placing or removing a checkmark in the adjacent toggle selector 108. A mouse may be used to alternately place or remove a checkmark from a toggle selector 108, such as by placing a cursor over the toggle selector 108 and left-clicking the mouse. In this example, the channels “Hayloft,” “Acoustix,” and “Classico” are selected as preferred channels, as indicated by the checkmarks in the toggle selectors 108 next to those three channels. The remaining toggle selectors 108 are currently unchecked.

A channel ratings column 106 of the GUI 100 provides the user-determined channel ratings currently associated with each channel in column 104. Here, the channel ratings are illustrated as star ratings, where each channel in column 104 has an associated rating of between one and five stars. The channel ratings may change over time. Optionally, the channel ratings may be manually selected by a user. Alternatively, the channel ratings may be automatically, dynamically determined on the basis of usage. For example, the channel rating for a particular satellite radio channel may increase or decrease over time in response to the user increasing or decreasing the frequency of selecting, or time spent listening to, that channel during a manual listening mode.

The input to the GUI 100 is used to customize the content to be stored and queued for playback in the system 10 of FIG. 1. In particular, the content to be stored and queued may be limited to content from the preferred channels selected in the GUI 100 of FIG. 2. The preferred channels may be dynamically selected by toggling the toggle selectors 108 during playback of the playback sequence 40 of FIG. 1. As the set of preferred channels changes, additional content saved and queued for subsequent playback will be taken from the currently-selected subset of preferred channels.

According to one embodiment, a user has the option to define one or more “custom radio stations” as shown in box 110. A custom radio station, in this embodiment, combines content from a subset of two or more of the available channels. Two custom radio stations are shown in FIG. 2, by way of example. The custom radio station “Evenings” includes content from the Hayloft, Acoustix, and Classico channels. The custom radio station “Mornings” includes content from Talk America and News. The descriptors Evenings and Mornings may be chosen by the user to reflect the period of the day the user prefers to receive content from the associated subset of stations.

A radio button 112 is provided next to the custom radio station with which it is associated. Each button is a user interface element that provides the user a way to select the custom radio button with which it is associated. Each button 112 may be a mechanical button pressed by hand that triggers an electronic response for selecting the associated radio station. More commonly, each button 112 is a virtual button, such as an element of a graphical user interface generated on the display screen of a computer, telephone, personal digital assistant (PDA), or other electronic device. A virtual button may be “pressed,” such as by clicking with a mouse or other pointing device, or by touching a touch-sensitive display screen. Here, each button 112 is defined by its unique set of parameters that include the associated button description (e.g. Evenings or Mornings) and graphical icon. The icon associated with a button is a graphical element, which usually includes a symbol or design, but may also include text. Pressing a radio button 112 selects the adjacent custom radio station. Evenings is the currently selected custom radio station. Clicking the radio button 112 associated with Evenings automatically selects the channels Hayloft, Acoustix, and Classico and deselects all other available channels, as indicated in column 102. When the Evenings custom radio station is selected, content from the three channels Hayloft, Acoustix, and Classico will be stored, queued, and played back by the system 10 of FIG. 1.

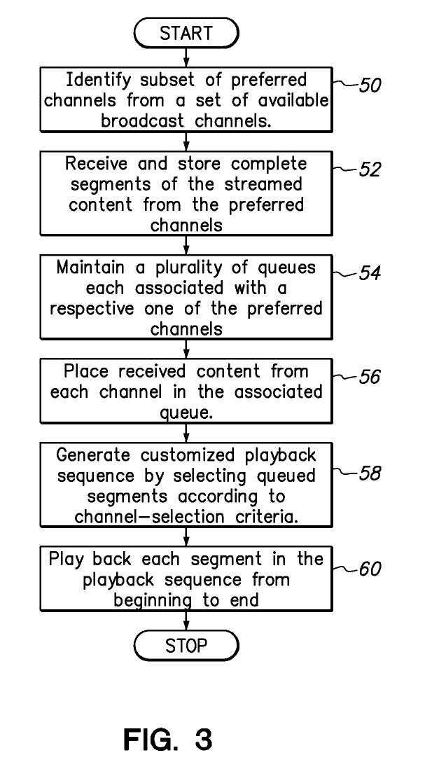

FIG. 3 is a flowchart outlining a method according to an embodiment of the invention. The method is merely one embodiment, and the invention is not limited to the steps shown. Various aspects of the recited steps may be further informed by reference to the related discussion of FIGS. 1 and 2.

In step 50, a subset of preferred channels from a set of available broadcast channels is identified. The available broadcast channels may include tens, hundreds, or even thousands of channels of a particular broadcast format. For example, the broadcast channels may be satellite radio channels that are transmitted by satellite in a streaming format. The broadcast channels are broadcast in a manner that conventional receivers and methods may be used to playback the content in real time, as the content is received.

In step 52, complete media segments of the streamed content from the preferred channels are received and stored, such as in the memory on a broadcast receiving device. According to step 54, a plurality of queues is maintained. Each queue is associated with a respective one of the preferred channels. Thus, for each of the preferred channels, a separate queue is maintained containing content only of the associated channel. In step 56, the received content from each channel is placed in the queue associated with that channel. The received content and the queues may be stored in the same memory device. The parameters of the queue also stored in memory may include a maximum allotted queue size, which may be expressed in memory units such as megabytes or gigabytes. The queue parameters may also include a limit on the number of media segments (e.g. a number of songs) that may be queued.

In step 58, a customized playback sequence is generated. Media segments stored in the queues are selected according to the channel-selection criteria. For example, the channel-selection criteria, such as channel ratings, may be used to select content queued from the preferred channels in relation to the channel ratings.

According to step 60, each media segment in the customized playback sequence is played back from beginning to end. Segment tags specifying the beginning and end of each media segment may be used to determine when a media segment should begin and end. Each media segment selected for the customized playback sequence may be selected from the bottom of the queue associated with the respective channel. Each media segment selected for inclusion in the customized playback sequence may be removed from the bottom of the queue from which it was selected. Each media segment in the playback sequence may be deleted from memory after the media segment has been fully played back, to help manage the finite amount of memory, as well as to manage the finite memory allocation for each queue.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
identifying a subset of preferred channels from a set of available broadcast channels, each broadcast channel providing streaming content including media segments;
receiving and storing complete media segments of the streamed content from the preferred channels;
maintaining a plurality of queues, including placing the received content from each channel in one of the queues in the order received;
generating a customized playback sequence by selecting the queued media segments according to channel-selection criteria; and
playing back media segments according to the customized playback sequence.

2. The method of claim 1, wherein the queues are equal in number to the subset of preferred channels, and wherein each queue is associated with a respective one of the preferred channels.

3. The method of claim 1, further comprising:
receiving segment tags identifying the beginning and end of each media segment; and
playing back each media segment in the playback sequence from beginning to end as identified by the segment tags.

4. The method of claim 1, further comprising:
including a channel rating for each of the preferred channels in the channel-selection criteria; and
selecting the queued media segments from each queue at a frequency weighted according to the channel rating of the associated channel.

5. The method of claim 4, wherein the channel rating includes one or more of a star rating, a numerical rating, or a text rating.

6. The method of claim 1, wherein the step of generating the customized playback sequence further comprises identifying the queue having a most recently received and stored media segment and adding a media segment from the bottom of the identified queue to the playback sequence.

7. The method of claim 1, further comprising:
periodically inserting a media segment from a specific queue into the playback sequence at a defined interval.

8. The method of claim 1, further comprising:
dynamically adding channels to the preferred subset of channels and removing channels from the preferred subset of channels in response to user input.

9. The method of claim 8, further comprising:
generating a user interface listing the available channels and providing a toggle selector for dynamically adding and removing the available channels from the subset of preferred channels;
adding an available channel to the subset of preferred channels in response to toggling the respective toggle selector from a first state to a second state; and
removing an available channel from the subset of preferred channels in response to toggling the respective toggle selector from the second state to the first state.

10. The method of claim 1, wherein the broadcast channels are streamed on a broadcast medium selected from the group consisting of airwaves, cable, and satellite.

11. The method of claim 1, wherein the selection criteria include prior usage patterns.

12. The method of claim 1, further comprising:
uniquely associating the subset of preferred channels with a button; and
in response to activating of the button, setting the preferred subset as the subset associated with the activated button.

13. The method of claim 1, further comprising:
uniquely associating each of a plurality of different subsets of the available channels with a corresponding plurality of buttons; and
in response to activating of one of the buttons, setting the preferred subset as the subset associated with the activated button.

14. A streaming media playback system, comprising:
a receiver configured for receiving and storing selected portions of a digitally-encoded multi-channel broadcast;
a digital decoder for decoding the multi-channel broadcast;
a demultiplexer for separating the multi-channel broadcast into separate channels;
a sequence generator for applying predefined channel-selection criteria to select channels, selecting complete media segments to be stored from the selected channels, queuing the stored media segments, and generating a playback sequence from the queued media segments; and
a media player for playing back all of the queued media content according to the playback sequence.

15. The streaming media playback system of claim 14, wherein the sequence generator is configured to maintain a separate queue for each selected channel.

16. A computer program product including computer usable program code embodied on a computer usable storage medium for providing a customized playback of streamed multimedia content, the computer program product including:
computer usable program code for identifying a subset of preferred channels from a set of available broadcast channels, each broadcast channel providing streaming content including media segments;
computer usable program code for receiving and storing complete media segments of the streamed content from the preferred channels;
computer usable program code for maintaining a plurality of queues, including placing the received content from each channel in one of the queues in the order received;
computer usable program code for generating a customized playback sequence by selecting the queued media segments according to channel-selection criteria; and
computer usable program code for playing back media segments according to the customized playback sequence.

17. The computer program product of claim 16, further comprising:
computer usable program code for receiving segment tags identifying the beginning and end of each media segment; and
computer usable program code for playing back each media segment in the playback sequence from beginning to end as identified by the segment tags.

18. The computer program product of claim 16, further comprising:
computer usable program code for including a channel rating for each of the preferred channels in the channel-selection criteria; and
computer usable program code for selecting the queued media segments from each queue at a frequency weighted according to the channel rating of the associated channel.

19. The computer program product of claim 18, wherein the channel rating includes one or more of a star rating, a numerical rating, or a text rating.

20. The computer program product of claim 16, wherein the computer usable program code for generating the customized playback sequence includes computer usable program code for identifying the queue having a most recently received and stored media segment and adding a media segment from the bottom of the identified queue to the playback sequence.
